(19) United States
(12) Patent Application Publication
(10) Pub. No.: US 2026/0370251 A1
(43) Pub. Date: Nov. 19, 2026

(54) RADIO-FREQUENCY CIRCUIT AND COMMUNICATION DEVICE

(71) Applicant: Murata Manufacturing Co., Ltd., Nagaokakyo-shi (JP)

(72) Inventors: Kunitoshi HANAOKA, Nagaokakyo-shi, Kyoto (JP); Takashi HIROSE, Nagaokakyo-shi, Kyoto (JP); Shogo YANASE, Nagaokakyo-shi, Kyoto (JP); Yoshihiro DAIMON, Nagaokakyo-shi, Kyoto (JP); Hisanori MURASE, Nagaokakyo-shi, Kyoto (JP); Ryoya SHIOMI, Nagaokakyo-shi, Kyoto (JP); Hideki ITOU, Nagaokakyo-shi, Kyoto (JP); Tsubasa UCHIDA, Nagaokakyo-shi, Kyoto (JP)

(73) Assignee: Murata Manufacturing Co., Ltd., Nagaokakyo-shi (JP)

(21) Appl. No.: 19/749,647

(22) Filed: Jul. 22, 2026

Related U.S. Application Data
(63) Continuation of application No. PCT/JP2025/004518, filed on Feb. 12, 2025.

(30) Foreign Application Priority Data
Feb. 27, 2024 (JP) 2024-027874

(51) Int. Cl. H04B 1/44

(52) U.S. Cl. CPC H04B 1/44

(57) ABSTRACT

A radio-frequency circuit includes a switching circuit including first to fourth common terminals respectively connected to first to fourth antenna connection terminals and first to fifth selection terminals. A first filter connected between the first common terminal and the first antenna connection terminal has a pass band including an ultra-high band group. A second filter connected between the second common terminal and the second antenna connection terminal has a pass band including an high band group. A third filter connected between the third common terminal and the third antenna connection terminal has a pass band including the high band group and a mid-band group. A fourth filter connected between the fourth common terminal and the fourth antenna connection terminal has a pass band including a low band group. A fifth filter connected between the second selection terminal and a receive circuit has an attenuation band including the high band group.

### CROSS-REFERENCE TO RELATED APPLICATIONS

This application is a continuation of International Application No. PCT/JP2025/004518, filed Feb. 12, 2025, which claims priority to Japanese Patent Application No. 2024-027874, filed Feb. 27, 2024, the entire contents of both of which are incorporated herein by reference in their entirety.

### TECHNICAL FIELD

The present disclosure relates to radio-frequency circuits and communication devices.

### BACKGROUND ART

In mobile communication devices such as mobile phones, front-end circuits are becoming larger as multiband technology advances. Patent Document 1 discloses a radio-frequency circuit including multiple filters for multiple frequency bands.

### CITATION LIST

### Patent Document

Patent Document 1: U.S. Patent Application Publication No. 2015/0133067

### SUMMARY

A radio-frequency circuit according to one embodiment of the present disclosure includes: a switching circuit including a first common terminal connected to a first antenna connection terminal, a second common terminal connected to a second antenna connection terminal, a third common terminal connected to a third antenna connection terminal, a fourth common terminal connected to a fourth antenna connection terminal, a first selection terminal connected to a first transmit circuit for an ultra high band group (3300-5000 MHz), a second selection terminal connected to a first receive circuit for the ultra high band group, a third selection terminal connected to at least one of a second transmit circuit and a second receive circuit for a high band group (2300-2690 MHz), a fourth selection terminal connected to at least one of a third transmit circuit and a third receive circuit for a mid band group (1427-2200 MHz), and a fifth selection terminal connected to at least one of a fourth transmit circuit and a fourth receive circuit for a low band group (617-960 MHz); a first filter connected between the first common terminal and the first antenna connection terminal, the first filter having a pass band that includes the ultra high band group; a second filter connected between the second common terminal and the second antenna connection terminal, the second filter having a pass band that includes the high band group; a third filter connected between the third common terminal and the third antenna connection terminal, the third filter having a pass band that includes the high band group and the mid band group; a fourth filter connected between the fourth common terminal and the fourth antenna connection terminal, the fourth filter having a pass band that includes the low band group; and a fifth filter connected between the second selection terminal and the first receive circuit, the fifth filter having an attenuation band that includes the high band group.

A communication device according to one embodiment of the present disclosure includes: a signal processing circuit configured to process a radio-frequency signal; and the radio-frequency circuit configured to deliver the radio-frequency signal between an antenna and the signal processing circuit.

According to the present disclosure, isolation between band groups can be improved in the radio-frequency circuit for multiple band groups.

### BRIEF DESCRIPTION OF DRAWINGS

FIG. 1 illustrates a circuit configuration of a communication device according to a first embodiment.

FIG. 2 illustrates transmit paths and receive paths in a first mode of a radio-frequency circuit according to the first embodiment.

FIG. 3 illustrates transmit paths and receive paths in a second mode of the radio-frequency circuit according to the first embodiment.

FIG. 4 illustrates transmit paths and receive paths in a third mode of the radio-frequency circuit according to the first embodiment.

FIG. 5 illustrates a circuit configuration of a communication device according to a second embodiment.

FIG. 6 illustrates transmit paths and receive paths in a first mode of a radio-frequency circuit according to the second embodiment.

FIG. 7 illustrates transmit paths and receive paths in a second mode of the radio-frequency circuit according to the second embodiment.

FIG. 8 illustrates transmit paths and receive paths in a third mode of the radio-frequency circuit according to the second embodiment.

### DESCRIPTION OF EMBODIMENTS

The inventors have recognized that if transmit and receive circuits for an ultra high band group are provided on the same module board as transmit and receive circuits for high band, mid band, and low band groups in order to miniaturize a radio-frequency circuit, isolation between the transmit and receive circuits for the ultra high band group and the transmit and receive circuits for the high band, mid band, and low band groups is difficult to ensure.

To address this and other issues, the present disclosure provides a radio-frequency circuit and a communication device for multiple band groups with improved isolation between the band groups.

Hereinafter, embodiments of the present disclosure will be described in detail with reference to the drawings. The embodiments described below represent comprehensive or specific examples. Details such as numerical values, shapes, materials, constituent elements, and arrangements and connection modes of the constituent elements provided in the following embodiments are illustrative and are not intended to limit the present disclosure.

The drawings are schematically illustrated with necessary emphasis, omissions, or proportion adjustments to depict the present disclosure and do not necessarily represent exact details; thus, the shapes, positional relationships, and proportions can differ from actual implementations. Identical reference numerals are assigned to substantially the same configuration elements across the drawings, and redundant descriptions of these configuration elements can be omitted or simplified.

In the following descriptions of circuit configurations, the term “connected” includes cases in which one circuit element is directly connected to another circuit element by connection terminals and/or interconnect conductors, and also includes cases in which one circuit element is electrically connected to another circuit element via another circuit element. The term “A is connected to B in a switchable manner” refers to a state in which A and B can be selectively connected or disconnected, and in which A is connected to B via switches. The term “A is connected to B” includes “A is connected to B in a switchable manner.” The term “C is connected between A and B” refers to a state in which one terminal of C is connected to A, and the other terminal of C is connected to B, and in which C is provided in series in a path connecting A and B. The term “a path connecting A and B” refers to a path formed of a conductor that electrically connects A and B.

The term “terminal” refers to a point at which a conductor within an element terminates. When the impedance of a conductor between elements is sufficiently low, the “terminal” is interpreted not only as a single point but also as any point in the conductor between the elements, or as the entire conductor.

The term “pass band of a filter” refers to a portion of a frequency spectrum that is transmitted through the filter, and is defined as a frequency range within which the output power is not attenuated by 3 dB or more relative to the maximum output power. Thus, the pass band of a band pass filter is defined as a frequency range between two points at which the output power is attenuated by 3 dB relative to the maximum output power. The pass band of a high pass filter is defined as a frequency range above a point (cutoff frequency) at which the output power is attenuated by 3 dB relative to the maximum output power. The pass band of a low pass filter is defined as a frequency range below a point (cutoff frequency) at which the output power is attenuated by 3 dB relative to the maximum output power.

The term “attenuation band of a filter” refers to a portion of a frequency spectrum that is attenuated by the filter, and is defined as a frequency range within which the output power is attenuated by 5 dB or more relative to the maximum output power. Thus, the attenuation band of a band elimination filter is defined as a frequency range between two points at which the output power is attenuated by 5 dB relative to the maximum output power. The attenuation band of a high pass filter is defined as a frequency range below a point at which the output power is attenuated by 5 dB relative to the maximum output power. The attenuation band of a low pass filter is defined as a frequency range above a point at which the output power is attenuated by 5 dB relative to the maximum output power.

The term “simultaneous communication of signals on multiple bands” refers to simultaneous transmission, simultaneous reception, or simultaneous transmission and reception of signals on multiple bands. Band combinations that allow simultaneous communication are defined by standardization organizations (for example, the 3rd Generation Partnership Project (3GPP) (registered trademark) and the Institute of Electrical and Electronics Engineers (IEEE)). Examples of simultaneous communication include carrier aggregation (CA), E-UTRAN New Radio-Dual Connectivity (EN-DC), New Radio-Dual Connectivity (NR-DC), and New Radio E-UTRAN-Dual Connectivity (NE-DC). The first mode, second mode, and third mode described herein each represent a configuration for simultaneous communication as defined above. For example, in the first mode, simultaneous communication of signals of the ultra high band group and signals of the high band group may be performed using carrier aggregation (CA), E-UTRAN New Radio-Dual Connectivity (EN-DC), New Radio-Dual Connectivity (NR-DC), or New Radio E-UTRAN-Dual Connectivity (NE-DC) as defined by 3GPP or IEEE standards. Similarly, the second mode and the third mode support simultaneous communication of signals of the ultra high band group with signals of the mid band group and the low band group, respectively, using the same communication schemes. In each mode, the switching circuit selectively connects the first common terminal to the first selection terminal or the second selection terminal at different times within a communication cycle, consistent with time-division operation within a given band group.

### First Embodiment

A first embodiment will now be described. A communication device 5 according to the present embodiment can be used to provide wireless connectivity. For example, the communication device 5 can be installed in user equipment (UE) in cellular networks (also called mobile networks), such as mobile phones, smartphones, tablet computers, and wearable devices. In another example, the communication device 5, when installed, can provide wireless connectivity for Internet of Things (IoT) sensor devices, medical/health-care devices, automobiles, unmanned aerial vehicles (UAVs) (drones), and automated guided vehicles (AGVs). In yet another example, the communication device 5, when installed, can provide wireless connectivity through wireless access points or wireless hotspots.

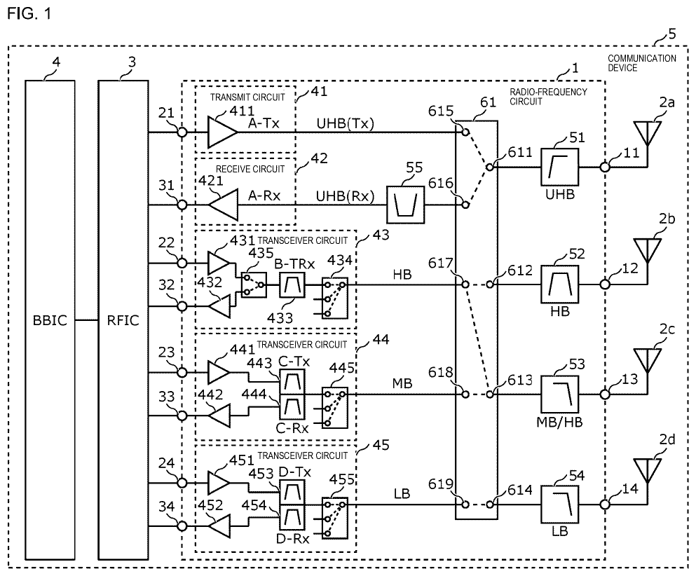

A circuit configuration of the communication device 5 and a radio-frequency circuit 1 according to the present embodiment will be described with reference to FIG. 1. FIG. 1 illustrates a circuit configuration of the communication device 5 according to the present embodiment.

FIG. 1 illustrates an exemplary circuit configuration. The communication device 5 and the radio-frequency circuit 1 may be implemented using various circuit implementations and circuit techniques. Hence, the descriptions of the communication device 5 and the radio-frequency circuit 1 provided below should not be interpreted as limiting.

### 1.1 Circuit Configuration of Communication Device 5

First, a circuit configuration of the communication device 5 according to the present embodiment will be described with reference to FIG. 1. The communication device 5 includes the radio-frequency circuit 1, antennas 2a, 2b, 2c, and 2d, a radio-frequency integrated circuit (RFIC) 3, and a baseband integrated circuit (BBIC) 4.

The radio-frequency circuit 1 is operable to deliver radio-frequency signals between the antennas 2a, 2b, 2c, and 2d and the RFIC 3. The circuit configuration of the radio-frequency circuit 1 will be described later.

The antennas 2a, 2b, 2c, and 2d are connected to antenna connection terminals 11, 12, 13, and 14 of the radio-frequency circuit 1. The antennas 2a, 2b, 2c, and 2d are operable to receive radio-frequency signals from the radio-frequency circuit 1 and transmit the radio-frequency signals to the outside of the communication device 5. The antennas 2a, 2b, 2c, and 2d are operable to receive radio-frequency signals from the outside of the communication device 5 and output the radio-frequency signals to the radio-frequency circuit 1. The antennas 2a, 2b, 2c, and 2d need not be included in the communication device 5. The communication device 5 may also include one or more antennas in addition to the antennas 2a, 2b, 2c, and 2d.

The RFIC 3 is an example of a signal processing circuit for processing radio-frequency signals. Specifically, the RFIC 3 is operable to process, for example by upconversion, transmit signals inputted from the BBIC 4 and output the radio-frequency transmit signals generated through the signal processing to the radio-frequency circuit 1. The RFIC 3 is operable to process, for example by downconversion, radio-frequency receive signals inputted through receive paths of the radio-frequency circuit 1 and output the receive signals generated by the signal processing to the BBIC 4. The RFIC 3 may include a control unit for controlling components included in the radio-frequency circuit 1, such as switches and power amplifiers. The function of the control unit of the RFIC 3 may be partially or entirely included outside the RFIC 3; for example, the function of the control unit of the RFIC 3 may be included in the BBIC 4 or the radio-frequency circuit 1.

The BBIC 4 is a baseband signal processing circuit configured to perform signal processing using a frequency range that is lower than radio-frequency signals delivered by the radio-frequency circuit 1. Signals processed by the BBIC 4 include, for example, image signals for image display and/or sound signals for calls through speakers. The BBIC 4 need not be included in the communication device 5.

### 1.2 Circuit Configuration of Radio-Frequency Circuit 1

Next, a circuit configuration of the radio-frequency circuit 1 according to the present embodiment will be described with reference to FIG. 1. The radio-frequency circuit 1 includes the antenna connection terminals 11, 12, 13, and 14, radio-frequency input terminals 21, 22, 23, and 24, radio-frequency output terminals 31, 32, 33, and 34, a transmit circuit 41, a receive circuit 42, transceiver circuits 43, 44, and 45, filters 51, 52, 53, 54, and 55, and a switching circuit 61.

The antenna connection terminals 11, 12, 13, and 14 are external connection terminals of the radio-frequency circuit 1. The antenna connection terminal 11 is an example of a first antenna connection terminal. The antenna connection terminal 11 is connected to the antenna 2a outside the radio-frequency circuit 1 and to the filter 51 inside the radio-frequency circuit 1. The antenna connection terminal 12 is an example of a second antenna connection terminal. The antenna connection terminal 12 is connected to the antenna 2b outside the radio-frequency circuit 1 and to the filter 52 inside the radio-frequency circuit 1. The antenna connection terminal 13 is an example of a third antenna connection terminal. The antenna connection terminal 13 is connected to the antenna 2c outside the radio-frequency circuit 1 and to the filter 53 inside the radio-frequency circuit 1. The antenna connection terminal 14 is an example of a fourth antenna connection terminal. The antenna connection terminal 14 is connected to the antenna 2d outside the radio-frequency circuit 1 and to the filter 54 inside the radio-frequency circuit 1. With this configuration, the radio-frequency circuit 1 can supply transmit signals to the antennas 2a, 2b, 2c, and 2d through the antenna connection terminals 11, 12, 13, and 14, and can receive signals from the antennas 2a, 2b, 2c, and 2d.

The radio-frequency input terminals 21, 22, 23, and 24 are external connection terminals of the radio-frequency circuit 1 and are connected to the RFIC 3 outside the radio-frequency circuit 1. The radio-frequency input terminals 21, 22, 23, and 24 are respectively connected to the transmit circuit 41 and the transceiver circuits 43, 44, and 45 inside the radio-frequency circuit 1. With this configuration, the radio-frequency circuit 1 can supply transmit signals received from the RFIC 3 through the radio-frequency input terminals 21, 22, 23, and 24 respectively to the transmit circuit 41 and the transceiver circuits 43, 44, and 45.

The radio-frequency output terminals 31, 32, 33, and 34 are external connection terminals of the radio-frequency circuit 1 and are connected to the RFIC 3 outside the radio-frequency circuit 1. The radio-frequency output terminals 31, 32, 33, and 34 are respectively connected to the receive circuit 42 and the transceiver circuits 43, 44, and 45 inside the radio-frequency circuit 1. With this configuration, the radio-frequency circuit 1 can supply receive signals output from the receive circuit 42 and the transceiver circuits 43, 44, and 45 to the RFIC 3 through the radio-frequency output terminals 31, 32, 33, and 34.

The transmit circuit 41 is an example of a first transmit circuit for an ultra high band group (UHB) (3300-5000 MHz). The transmit circuit 41 is connected between the radio-frequency input terminal 21 and the switching circuit 61. The transmit circuit 41 includes a power amplifier 411. The input terminal of the power amplifier 411 is connected to the radio-frequency input terminal 21, and the output terminal of the power amplifier 411 is connected to a selection terminal 615 of the switching circuit 61. The power amplifier 411 is operable to amplify transmit signals (A-Tx) of a band A, which is included in the UHB, using power supplied by a power supply.

The circuit configuration of the transmit circuit 41 is illustrative, and the configuration illustrated in FIG. 1 should not be interpreted as limiting. For example, the transmit circuit 41 may further include filters corresponding to other bands included in the UHB or to the band A.

The receive circuit 42 is an example of a first receive circuit for the UHB. The receive circuit 42 is connected between the switching circuit 61 and the radio-frequency output terminal 31. The receive circuit 42 includes a low-noise amplifier 421. The input terminal of the low-noise amplifier 421 is connected to a selection terminal 616 of the switching circuit 61 via the filter 55, and the output terminal of the low-noise amplifier 421 is connected to the radio-frequency output terminal 31. The low-noise amplifier 421 is operable to amplify receive signals (A-Rx) of the band A, which is included in the UHB, using power supplied by a power supply.

The circuit configuration of the receive circuit 42 is illustrative, and the configuration illustrated in FIG. 1 should not be interpreted as limiting. For example, the receive circuit 42 may further include filters corresponding to other bands included in the UHB or to the band A.

The transceiver circuit 43 is an example of a second transmit circuit and a second receive circuit for a high band group (HB) (2300-2690 MHz). The transceiver circuit 43 is connected between the switching circuit 61 and the radio-frequency input terminal 22 and the radio-frequency output terminal 32. The transceiver circuit 43 includes a power amplifier 431, a low-noise amplifier 432, a filter 433, and switching circuits 434 and 435.

The input terminal of the power amplifier 431 is connected to the radio-frequency input terminal 22, and the output terminal of the power amplifier 431 is connected to the switching circuit 435. The power amplifier 431 is operable to amplify transmit signals of a band B, which is included in the HB, using power supplied by a power supply.

The input terminal of the low-noise amplifier 432 is connected to the switching circuit 435, and the output terminal of the low-noise amplifier 432 is connected to the radio-frequency output terminal 32. The low-noise amplifier 432 is operable to amplify receive signals of the band B, which is included in the HB, using power supplied by a power supply.

The filter 433 has a pass band including the band B included in the HB. One terminal of the filter 433 is connected to the switching circuit 434, and the other terminal of the filter 433 is connected to the switching circuit 435. The filter 433 is operable to pass transmit and receive signals (B-TRx) of the band B.

The switching circuit 434 includes a common terminal and multiple selection terminals. The common terminal of the switching circuit 434 is connected to a selection terminal 617 of the switching circuit 61. One of the multiple selection terminals of the switching circuit 434 is connected to the filter 433. With this connection configuration, the switching circuit 434 is operable to connect the common terminal to at least one of the multiple selection terminals, for example, in response to a control signal from the RFIC 3. The switching circuit 434 is implemented as, for example, a multi-connection switching circuit.

The switching circuit 435 includes a common terminal and two selection terminals. The common terminal of the switching circuit 435 is connected to the filter 433. One of the two selection terminals of the switching circuit 435 is connected to the power amplifier 431, and the other of the two selection terminals of the switching circuit 435 is connected to the low-noise amplifier 432. With this connection configuration, the switching circuit 435 is operable to exclusively connect the common terminal to one of the two selection terminals, for example, in response to a control signal from the RFIC 3. The switching circuit 435 is implemented as, for example, a single-pole double-throw (SPDT) switching circuit.

The circuit configuration of the transceiver circuit 43 is illustrative, and the configuration illustrated in FIG. 1 should not be interpreted as limiting. For example, the transceiver circuit 43 may further include other filters corresponding to other bands included in the HB. In this case, the other filters may be connected to other selection terminals of the switching circuit 434. Furthermore, in FIG. 1, the band B is a time-division duplex (TDD) band. However, the band B may be a frequency-division duplex (FDD) band. In this case, the filter 433 is replaced with a duplexer, and the switching circuit 435 may be omitted.

The transceiver circuit 44 is an example of a third transmit circuit and a third receive circuit for a mid band group (MB) (1427-2200 MHz). The transceiver circuit 44 is connected between the switching circuit 61 and the radio-frequency input terminal 23 and the radio-frequency output terminal 33. The transceiver circuit 44 includes a power amplifier 441, a low-noise amplifier 442, filters 443 and 444, and a switching circuit 445.

The input terminal of the power amplifier 441 is connected to the radio-frequency input terminal 23, and the output terminal of the power amplifier 441 is connected to the filter 443. The power amplifier 441 is operable to amplify transmit signals of a band C, which is included in the MB, using power supplied by a power supply.

The input terminal of the low-noise amplifier 442 is connected to the filter 444, and the output terminal of the low-noise amplifier 442 is connected to the radio-frequency output terminal 33. The low-noise amplifier 442 is operable to amplify receive signals of the band C, which is included in the MB, using power supplied by a power supply.

The filter 443 has a pass band including a transmit band of the band C included in the MB. One terminal of the filter 443 is connected to the switching circuit 445, and the other terminal of the filter 443 is connected to the power amplifier 441. The filter 443 is operable to pass transmit signals (C-Tx) of the band C.

The filter 444 has a pass band including a receive band of the band C included in the MB. One terminal of the filter 444 is connected to the switching circuit 445, and the other terminal of the filter 444 is connected to the low-noise amplifier 442. The filter 444 is operable to pass receive signals (C-Rx) of the band C.

The switching circuit 445 includes a common terminal and multiple selection terminals. The common terminal of the switching circuit 445 is connected to a selection terminal 618 of the switching circuit 61. One of the multiple selection terminals of the switching circuit 445 is connected to the filters 443 and 444. With this connection configuration, the switching circuit 445 is operable to connect the common terminal to at least one of the multiple selection terminals, for example, in response to a control signal from the RFIC 3. The switching circuit 445 is implemented as, for example, a multi-connection switching circuit.

The circuit configuration of the transceiver circuit 44 is illustrative, and the configuration illustrated in FIG. 1 should not be interpreted as limiting. For example, the transceiver circuit 44 may further include one or more other filters corresponding to one or more bands included in the MB. In this case, the one or more filters may be connected to other selection terminals of the switching circuit 445.

The transceiver circuit 45 is an example of a fourth transmit circuit and a fourth receive circuit for a low band group (LB) (617-960 MHz). The transceiver circuit 45 is connected between the switching circuit 61 and the radio-frequency input terminal 24 and the radio-frequency output terminal 34. The transceiver circuit 45 includes a power amplifier 451, a low-noise amplifier 452, filters 453 and 454, and a switching circuit 455.

The input terminal of the power amplifier 451 is connected to the radio-frequency input terminal 24, and the output terminal of the power amplifier 451 is connected to the filter 453. The power amplifier 451 is operable to amplify transmit signals of a band D, which is included in the LB, using power supplied by a power supply.

The input terminal of the low-noise amplifier 452 is connected to the filter 454, and the output terminal of the low-noise amplifier 452 is connected to the radio-frequency output terminal 34. The low-noise amplifier 452 is operable to amplify receive signals of the band D, which is included in the LB, using power supplied by a power supply.

The filter 453 has a pass band including a transmit band of the band D included in the LB. One terminal of the filter 453 is connected to the switching circuit 455, and the other terminal of the filter 453 is connected to the power amplifier 451. The filter 453 is operable to pass transmit signals (D-Tx) of the band D.

The filter 454 has a pass band including a receive band of the band D included in the LB. One terminal of the filter 454 is connected to the switching circuit 455, and the other terminal of the filter 454 is connected to the low-noise amplifier 452. The filter 454 is operable to pass receive signals (D-Rx) of the band D.

The switching circuit 455 includes a common terminal and multiple selection terminals. The common terminal of the switching circuit 455 is connected to a selection terminal 619 of the switching circuit 61. One of the multiple selection terminals of the switching circuit 455 is connected to the filters 453 and 454. With this connection configuration, the switching circuit 455 is operable to connect the common terminal to at least one of the multiple selection terminals, for example, in response to a control signal from the RFIC 3. The switching circuit 455 is implemented as, for example, a multi-connection switching circuit.

The circuit configuration of the transceiver circuit 45 is illustrative, and the configuration illustrated in FIG. 1 should not be interpreted as limiting. For example, the transceiver circuit 45 may further include one or more other filters corresponding to one or more bands included in the LB. In this case, the one or more filters may be connected to other selection terminals of the switching circuit 455.

The filter 51 is an example of a first filter. The filter 51 is a high pass filter (HPF) having a pass band that includes the UHB. The filter 51 is connected between the common terminal 611 of the switching circuit 61 and the antenna connection terminal 11. The filter 51 is operable to pass signals of frequency bands included in the UHB. The filter 51 may be a band pass filter (BPF).

The filter 52 is an example of a second filter. The filter 52 is a BPF having a pass band that includes the HB. The filter 52 is connected between the common terminal 612 of the switching circuit 61 and the antenna connection terminal 12. The filter 52 is operable to pass signals of frequency bands included in the HB.

The filter 53 is an example of a third filter. The filter 53 is a low pass filter (LPF) having a pass band that includes the MB. The filter 53 is connected between the common terminal 613 of the switching circuit 61 and the antenna connection terminal 13. The filter 53 is operable to pass signals of frequency bands included in the MB. The filter 53 may be a BPF. The pass band of filter 53 may include both the high band group (2300-2690 MHz) and the mid band group (1427-2200 MHz61

The filter 54 is an example of a fourth filter. The filter 54 is an LPF having a pass band that includes the LB. The filter 54 is connected between the common terminal 614 of the switching circuit 61 and the antenna connection terminal 14. The filter 54 is operable to pass signals of frequency bands included in the LB. The filter 54 may be a BPF.

The filter 55 is an example of a fifth filter. The filter 55 is a band elimination filter (BEF) having an attenuation band that includes the HB and having a pass band that includes the UHB. The filter 55 is connected between the selection terminal 616 of the switching circuit 61 and the receive circuit 42. The filter 55 is operable to attenuate signals of frequency bands included in the HB and to pass signals of frequency bands included in the UHB. Alternatively, the filter 55 may be implemented as a band pass filter (BPF) having a pass band centered on the ultra high band group, which similarly attenuates signals outside the ultra high band group, including the high band group. The attenuation band of filter 55 may include harmonic bands of the LB and/or the MB in addition to the HB.

The filters 51 to 55 may be implemented as LC filters, surface acoustic wave (SAW) filters, bulk acoustic wave (BAW) filters, dielectric resonator filters, or any combination thereof. However, these examples should not be interpreted as limiting.

The switching circuit 61 includes common terminals 611, 612, 613, and 614 and the selection terminals 615, 616, 617, 618, and 619. The common terminal 611 is an example of a first common terminal. The common terminal 611 is connected to the antenna connection terminal 11 via the filter 51. The common terminal 612 is an example of a second common terminal. The common terminal 612 is connected to the antenna connection terminal 12 via the filter 52. The common terminal 613 is an example of a third common terminal. The common terminal 613 is connected to the antenna connection terminal 13 via the filter 53. The common terminal 614 is an example of a fourth common terminal. The common terminal 614 is connected to the antenna connection terminal 14 via the filter 54. The selection terminal 615 is an example of a first selection terminal. The selection terminal 615 is connected to the transmit circuit 41. The selection terminal 616 is an example of a second selection terminal. The selection terminal 616 is connected to the receive circuit 42 via the filter 55. The selection terminal 617 is an example of a third selection terminal. The selection terminal 617 is connected to the transceiver circuit 43. The selection terminal 618 is an example of a fourth selection terminal. The selection terminal 618 is connected to the transceiver circuit 44. The selection terminal 619 is an example of a fifth selection terminal. The selection terminal 619 is connected to the transceiver circuit 45.

With this connection configuration, the switching circuit 61 is operable to connect the common terminals 611 to 614 to the selection terminals 615 to 619, for example, in response to a control signal from the RFIC 3. Specifically, the common terminal 611 can be exclusively connected to one of the selection terminals 615 and 616; the common terminal 612 can be connected to the selection terminal 617; the common terminal 613 can be connected to the selection terminals 617 and 618; and the common terminal 614 can be connected to the selection terminal 619. In other words, the switching circuit 61 connects the common terminal 611 to one of the selection terminals 615 or 616 at a given time, enabling time-division switching between transmission and reception for the ultra high band group. The connections between the common terminals and the selection terminals of the switching circuit are switchable connections as described above, meaning that the switching circuit selectively establishes or interrupts those connections in response to a control signal. This distinction is reflected in the figures, in which filters 51 through 54 are depicted as fixed elements in the paths between the common terminals and the antenna connection terminals, while the switching circuit 61 provides the selective routing between the common terminals and the selection terminals connected to the transmit and receive circuits.

The switching circuit 61 may be implemented in a single integrated circuit. In this case, the integrated circuit may be constructed using, for example, complementary metal-oxide semiconductor (CMOS) technology and produced through a silicon-on-insulator (SOI) process. The integrated circuit is not limited to CMOS technology. The switching circuit 61 may be implemented in multiple integrated circuits. For example, the switching circuit 61 may be implemented in separate integrated circuits: one for the UHB, HB, and MB, and the other for the LB. In this case, the integrated circuit for the UHB, HB, and MB includes the common terminals 611 to 613 and the selection terminals 615 to 618, while the integrated circuit for the LB includes the common terminal 614 and the selection terminal 619.

### 1.3 Frequency Bands

Next, frequency bands supported by the radio-frequency circuit 1 will be described.

The bands A to D are frequency bands for communication systems built using a radio access technology (RAT). The bands A to D are defined by standardization organizations (for example, 3GPP and IEEE). Examples of the communication systems include a 5th Generation New Radio (5G NR) system, a Long-Term Evolution (LTE) system, and a wireless local area network (WLAN) system.

Examples of the bands A to D are listed in Table 1 below. In the table below, bands starting with the letter ‘n’ represent frequency bands for 5G NR, and bands starting with the letter ‘B’ represent frequency bands for LTE.

TABLE 1

| Band group | Band | 5GNR/LTE |
|---|---|---|
| UHB | Band A | n77, n78, n79 |
| HB | Band B | n7, B7, n40, B40, n41, B41 |
| MB | Band C | n1, B1, n3, B3 |
| LB | Band D | n8, B8, n26, B26, n28, B28 |

The bands A to D are not limited to Table 1.

### 1.4 Communication Mode

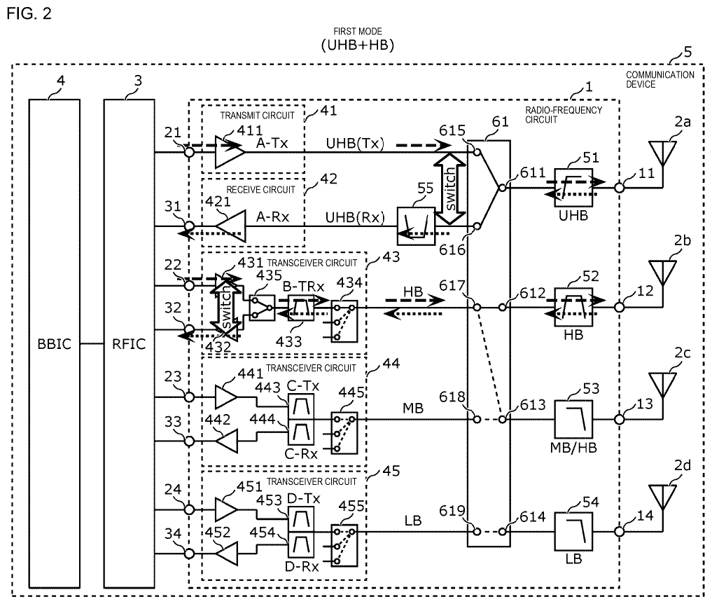

Next, as communication modes for simultaneous communication of signals of frequency bands included in the UHB and signals of frequency bands included in the HB, MB, or LB, a first mode, a second mode, and a third mode will be described with reference to FIGS. 2 to 4. In FIGS. 2 to 4, the dashed arrows indicate transmit paths and receive paths.

### 1.4.1 First Mode

First, the first mode will be described with reference to FIG. 2. FIG. 2 illustrates transmit paths and receive paths in the first mode of the radio-frequency circuit 1 according to the present embodiment.

The first mode is a communication mode for simultaneous communication of signals of the band A, which is included in the UHB, and signals of the band B, which is included in the HB. In the first mode, as illustrated in FIG. 2, the transmit circuit 41 for the UHB is connected to the antenna connection terminal 11 via the filter 51, the receive circuit 42 for the UHB is connected to the antenna connection terminal 11 via the filters 55 and 51, and the transceiver circuit 43 for the HB is connected to the antenna connection terminal 12 via the filter 52. Specifically, the switching circuit 61 selectively connects the common terminal 611 to the selection terminal 615 or 616 at different times and connects the common terminal 612 to the selection terminal 617.

With this configuration, transmit signals of the band A supplied from the RFIC 3 through the radio-frequency input terminal 21 are delivered to the antenna connection terminal 11 through the transmit circuit 41, the switching circuit 61, and the filter 51. Receive signals of the band A supplied from the antenna 2a through the antenna connection terminal 11 are delivered to the radio-frequency output terminal 31 through the filter 51, the switching circuit 61, the filter 55, and the receive circuit 42. Transmit signals of the band B supplied from the RFIC 3 through the radio-frequency input terminal 22 are delivered to the antenna connection terminal 12 through the transceiver circuit 43, the switching circuit 61, and the filter 52. Receive signals of the band B supplied from the antenna 2b via the antenna connection terminal 12 are transmitted to the radio-frequency output terminal 32 through the filter 52, the switching circuit 61, and the transceiver circuit 43.

### 1.4.2 Second Mode

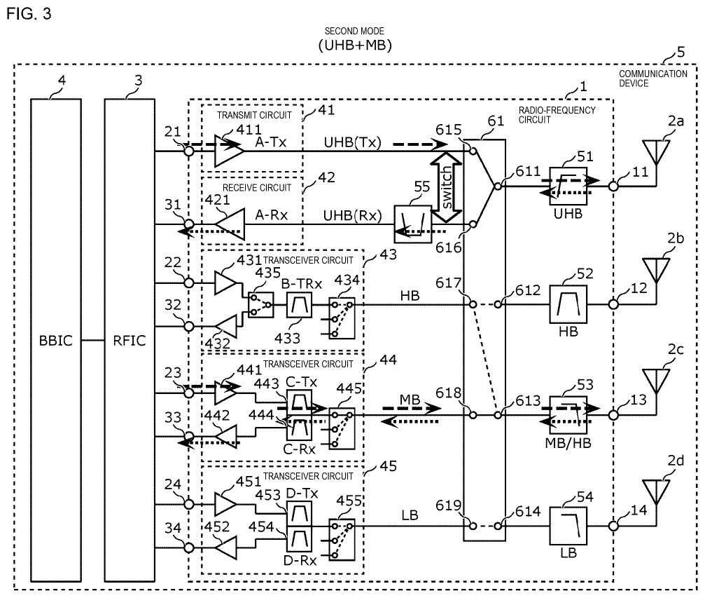

Next, the second mode will be described with reference to FIG. 3. FIG. 3 illustrates transmit paths and receive paths in the second mode of the radio-frequency circuit 1 according to the present embodiment.

The second mode is a communication mode for simultaneous communication of signals of the band A, which is included in the UHB, and signals of the band C, which is included in the MB. In the second mode, as illustrated in FIG. 3, the transmit circuit 41 for the UHB is connected to the antenna connection terminal 11 via the filter 51, the receive circuit 42 for the UHB is connected to the antenna connection terminal 11 via the filters 55 and 51, and the transceiver circuit 44 for the MB is connected to the antenna connection terminal 13 via the filter 53. Specifically, the switching circuit 61 selectively connects the common terminal 611 to the selection terminal 615 or 616 at different times and connects the common terminal 613 to the selection terminal 618.

With this configuration, transmit signals of the band A supplied from the RFIC 3 through the radio-frequency input terminal 21 are delivered to the antenna connection terminal 11 through the transmit circuit 41, the switching circuit 61, and the filter 51. Receive signals of the band A supplied from the antenna 2a through the antenna connection terminal 11 are delivered to the radio-frequency output terminal 31 through the filter 51, the switching circuit 61, the filter 55, and the receive circuit 42. Transmit signals of the band C supplied from the RFIC 3 through the radio-frequency input terminal 23 are delivered to the antenna connection terminal 13 through the transceiver circuit 44, the switching circuit 61, and the filter 53. Receive signals of the band C supplied from the antenna 2c via the antenna connection terminal 13 are transmitted to the radio-frequency output terminal 33 through the filter 53, the switching circuit 61, and the transceiver circuit 44.

### 1.4.3 Third Mode

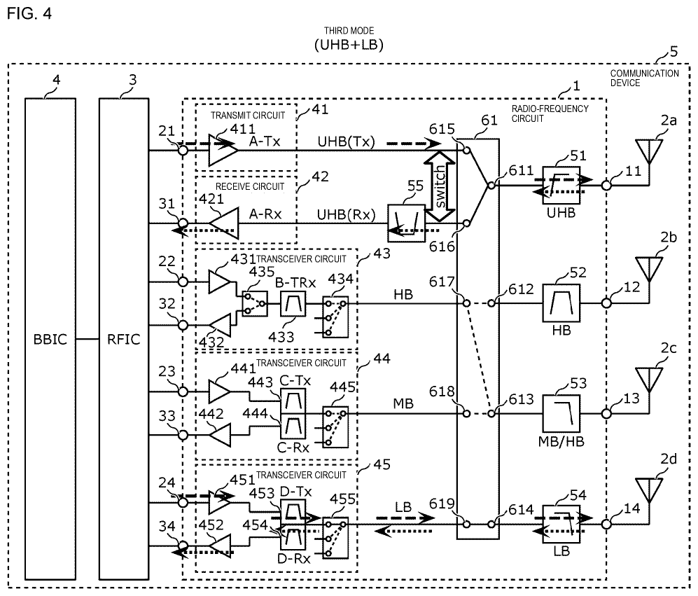

Finally, the third mode will be described with reference to FIG. 4. FIG. 4 illustrates transmit paths and receive paths in the third mode of the radio-frequency circuit 1 according to the present embodiment.

The third mode is a communication mode for simultaneous communication of signals of the band A, which is included in the UHB, and signals of the band D, which is included in the LB. In the third mode, as illustrated in FIG. 4, the transmit circuit 41 for the UHB is connected to the antenna connection terminal 11 via the filter 51, the receive circuit 42 for the UHB is connected to the antenna connection terminal 11 via the filters 55 and 51, and the transceiver circuit 45 for the LB is connected to the antenna connection terminal 14 via the filter 54. Specifically, the switching circuit 61 selectively connects the common terminal 611 to the selection terminal 615 or 616 at different times and connects the common terminal 614 to the selection terminal 619.

With this configuration, transmit signals of the band A supplied from the RFIC 3 through the radio-frequency input terminal 21 are delivered to the antenna connection terminal 11 through the transmit circuit 41, the switching circuit 61, and the filter 51. Receive signals of the band A supplied from the antenna 2a through the antenna connection terminal 11 are delivered to the radio-frequency output terminal 31 through the filter 51, the switching circuit 61, the filter 55, and the receive circuit 42. Transmit signals of the band D supplied from the RFIC 3 through the radio-frequency input terminal 24 are delivered to the antenna connection terminal 14 through the transceiver circuit 45, the switching circuit 61, and the filter 54. Receive signals of the band D supplied from the antenna 2d via the antenna connection terminal 14 are transmitted to the radio-frequency output terminal 34 through the filter 54, the switching circuit 61, and the transceiver circuit 45.

The first mode, the second mode, and the third mode have been described above with reference to FIGS. 2 to 4. However, multiple communication modes that the radio-frequency circuit 1 can utilize are not limited to the first mode, the second mode, and the third mode. For example, communication modes that enable simultaneous communication using a combination of HB and MB, a combination of MB and LB, a combination of HB and LB, a combination of UHB, HB, and MB, a combination of UHB, HB, and LB, a combination of UHB, MB, and LB, or a combination of UHB, HB, MB, and LB may be usable. Alternatively, for example, communication modes for communication on one or more frequency bands included in a single band group may be usable.

### 1.5 Conclusion

As described above, the radio-frequency circuit 1 according to the present embodiment includes: the switching circuit 61 including the common terminal 611 connected to the antenna connection terminal 11, the common terminal 612 connected to the antenna connection terminal 12, the common terminal 613 connected to the antenna connection terminal 13, the common terminal 614 connected to the antenna connection terminal 14, the selection terminal 615 connected to the transmit circuit 41 for the UHB, the selection terminal 616 connected to the receive circuit 42 for the UHB, the selection terminal 617 connected to the transceiver circuit 43 for the HB, the selection terminal 618 connected to the transceiver circuit 44 for the MB, and the selection terminal 619 connected to the transceiver circuit 45 for the LB; the filter 51 connected between the common terminal 611 and the antenna connection terminal 11, the filter 51 having a pass band that includes the UHB; the filter 52 connected between the common terminal 612 and the antenna connection terminal 12, the filter 52 having a pass band that includes the HB; the filter 53 connected between the common terminal 613 and the antenna connection terminal 13, the filter 53 having a pass band that includes the HB and the MB; the filter 54 connected between the common terminal 614 and the antenna connection terminal 14, the filter 54 having a pass band that includes the LB; and the filter 55 connected between the selection terminal 616 and the receive circuit 42, the filter 55 having an attenuation band that includes the HB.

In this configuration, the filter 55 having an attenuation band that includes the HB is connected between the selection terminal 616 of the switching circuit 61 and the receive circuit 42. Thus, leakage of signals of the HB into the receive path for the UHB can be suppressed. As a result, when the radio-frequency circuit 1 for the UHB, HB, MB, and LB is implemented on a single module board (in other words, when the radio-frequency circuit 1 is implemented as a single module), isolation between the receive circuit 42 for the UHB and the transceiver circuit 43 for the HB can be ensured, thereby contributing to miniaturization of the communication device 5. Furthermore, in the radio-frequency circuit 1, the switching circuit 61 switches between transmission and reception of signals of the UHB, and the filter 55 is not inserted into the transmit path for the UHB. This configuration can suppress loss of transmit signals of the UHB caused by the filter 55.

In one example, in the radio-frequency circuit 1 according to the present embodiment, the filter 51 may be a high pass filter.

This configuration can relatively easily implement the filter 51.

In one example, in the radio-frequency circuit 1 according to the present embodiment, the filter 51 may be a band pass filter.

This configuration enables the filter 51 to attenuate harmonic distortion in the transmit paths for the UHB and/or the receive paths for the UHB.

In one example, in the radio-frequency circuit 1 according to the present embodiment, the filter 51 may be an LC filter.

Since an LC filter, which has relatively low loss and a wide pass band, is used for the filter 51 in this configuration, filter characteristics suitable for the UHB, which is a relatively wide band, can be achieved with the filter 51.

In one example, in the radio-frequency circuit 1 according to the present embodiment, the filter 55 may be an LC filter.

Since an LC filter, which has relatively low loss and a wide attenuation band, is used for the filter 55 in this configuration, filter characteristics suitable for attenuating signals of the HB, which is a relatively wide band, can be achieved with the filter 55.

In one example, in the radio-frequency circuit 1 according to the present embodiment, in the first mode for simultaneous communication of UHB signals and HB signals, the switching circuit 61 may (i) selectively connect the common terminal 611 to the selection terminal 615 or 616 at different times and (ii) connect the common terminal 612 to the selection terminal 617; in the second mode for simultaneous communication of UHB signals and MB signals, the switching circuit 61 may (iii) selectively connect the common terminal 611 to the selection terminal 615 or 616 at different times and (iv) connect the common terminal 613 to the selection terminal 618; in the third mode for simultaneous communication of UHB signals and LB signals, the switching circuit 61 may (v) selectively connect the common terminal 611 to the selection terminal 615 or 616 at different times and (vi) connect the common terminal 614 to the selection terminal 619.

This configuration can realize simultaneous communication of UHB signals and HB, MB, or LB signals. In particular, in the radio-frequency circuit 1, which can suppress the loss of UHB transmit signals while suppressing leakage of HB signals into receive paths for the UHB, transmission and/or reception characteristics can be significantly improved in the first mode for simultaneous communication of UHB signals and HB signals.

In one example, the communication device 5 according to the present embodiment includes the RFIC 3 for processing radio-frequency signals and the radio-frequency circuit 1 for delivering radio-frequency signals between the antennas 2a to 2d and the RFIC 3.

This configuration enables the communication device 5 to achieve the same effects as the radio-frequency circuit 1.

### Second Embodiment

Next, a second embodiment will be described. The present embodiment differs from the first embodiment in that the receive circuit for the UHB can be selectively connected to and disconnected from the BEF. In the following, the present embodiment will be described with reference to the drawings, focusing primarily on features that differ from the first embodiment.

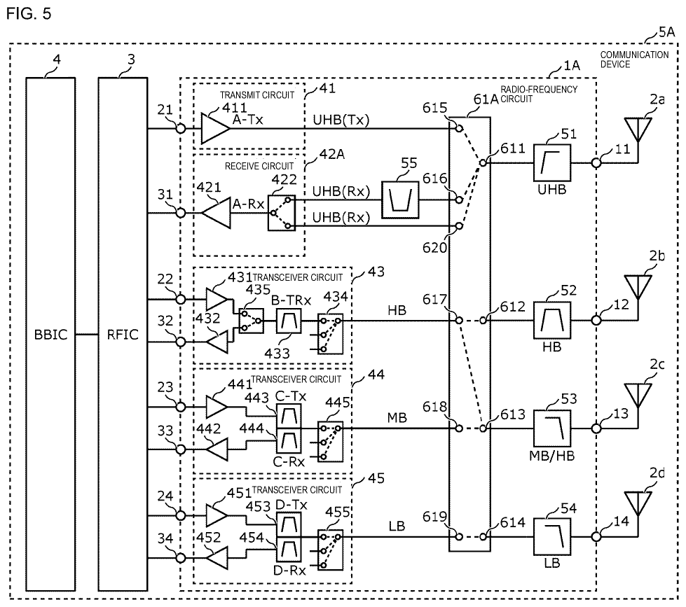

FIG. 5 is a circuit configuration diagram of a communication device 5A according to the present embodiment. FIG. 5 illustrates an exemplary circuit configuration. The communication device 5A and a radio-frequency circuit 1A may be implemented using various circuit implementations and circuit techniques. Hence, the descriptions of the communication device 5A and the radio-frequency circuit 1A provided below should not be interpreted as limiting.

### 2.1 Circuit Configuration of Communication Device 5A

The communication device 5A according to the present embodiment includes the radio-frequency circuit 1A, antennas 2a, 2b, 2c, and 2d, an RFIC 3, and a BBIC 4. The communication device 5A is the same as the communication device 5 according to the first embodiment, except that the communication device 5A includes the radio-frequency circuit 1A instead of the radio-frequency circuit 1. Accordingly, detailed descriptions thereof will be omitted.

### 2.2 Circuit Configuration of Radio-Frequency Circuit 1A

Next, a circuit configuration of the radio-frequency circuit 1A according to the present embodiment will be described with reference to FIG. 5. The radio-frequency circuit 1A includes antenna connection terminals 11, 12, 13, and 14, radio-frequency input terminals 21, 22, 23, and 24, radio-frequency output terminals 31, 32, 33, and 34, a transmit circuit 41, a receive circuit 42A, transceiver circuits 43, 44, and 45, filters 51, 52, 53, 54, and 55, and a switching circuit 61A.

The receive circuit 42A is an example of a first receive circuit for the UHB. The receive circuit 42A is connected between the switching circuit 61A and the radio-frequency output terminal 31. The receive circuit 42A includes a low-noise amplifier 421 and a switching circuit 422.

The input terminal of the low-noise amplifier 421 is connected to the switching circuit 422, and the output terminal of the low-noise amplifier 421 is connected to the radio-frequency output terminal 31. The low-noise amplifier 421 is operable to amplify receive signals (A-Rx) of the band A, which is included in the UHB, using power supplied by a power supply.

The switching circuit 422 includes a common terminal and two selection terminals. The common terminal of the switching circuit 422 is connected to the low-noise amplifier 421. One of the two selection terminals of the switching circuit 422 is connected to a selection terminal 616 of the switching circuit 61A via the filter 55, and the other of the two selection terminals of the switching circuit 422 is connected to a selection terminal 620 of the switching circuit 61A without the filter 55 being involved. With this connection configuration, the switching circuit 422 is operable to exclusively connect the common terminal to one of the two selection terminals, for example, in response to a control signal from the RFIC 3. The switching circuit 422 is implemented by, for example, a SPDT switching circuit.

The switching circuit 61A includes common terminals 611, 612, 613, and 614 and selection terminals 615, 616, 617, 618, 619, and 620. The common terminal 611 is an example of a first common terminal. The common terminal 611 is connected to the antenna connection terminal 11 via the filter 51. The common terminal 612 is an example of a second common terminal. The common terminal 612 is connected to the antenna connection terminal 12 via the filter 52. The common terminal 613 is an example of a third common terminal. The common terminal 613 is connected to the antenna connection terminal 13 via the filter 53. The common terminal 614 is an example of a fourth common terminal and is connected to the antenna connection terminal 14 via the filter 54. The selection terminal 615 is an example of a first selection terminal. The selection terminal 615 is connected to the transmit circuit 41. The selection terminal 616 is an example of a second selection terminal. The selection terminal 616 is connected to the receive circuit 42A via the filter 55. The selection terminal 617 is an example of a third selection terminal. The selection terminal 617 is connected to the transceiver circuit 43. The selection terminal 618 is an example of a fourth selection terminal. The selection terminal 618 is connected to the transceiver circuit 44. The selection terminal 619 is an example of a fifth selection terminal. The selection terminal 619 is connected to the transceiver circuit 45. The selection terminal 620 is an example of a sixth selection terminal. The selection terminal 620 is connected to the receive circuit 42A without the filter 55 being involved.

With this connection configuration, the switching circuit 61A is operable to connect the common terminals 611 to 614 to the selection terminals 615 to 620, for example, in response to a control signal from the RFIC 3. Specifically, the common terminal 611 can be exclusively connected to one of the selection terminals 615, 616, and 620; the common terminal 612 can be connected to the selection terminal 617; the common terminal 613 can be connected to the selection terminals 617 and 618; and the common terminal 614 can be connected to the selection terminal 619.

The switching circuit 61A may be implemented in a single integrated circuit. In this case, the integrated circuit may be constructed using, for example, CMOS technology and produced through an SOI process. The integrated circuit is not limited to CMOS technology. The switching circuit 61A may be implemented in multiple integrated circuits. For example, the switching circuit 61A may be implemented in separate integrated circuits: one for the UHB, HB, and MB, and the other for the LB. In this case, the integrated circuit for the UHB, HB, and MB includes the common terminals 611 to 613 and the selection terminals 615 to 618 and 620, while the integrated circuit for the LB includes the common terminal 614 and the selection terminal 619.

### 2.3 Frequency Bands

Frequency bands supported by the radio-frequency circuit 1A are the same as the frequency bands of the radio-frequency circuit 1 according to the first embodiment, so descriptions thereof will be omitted.

### 2.4 Communication Mode

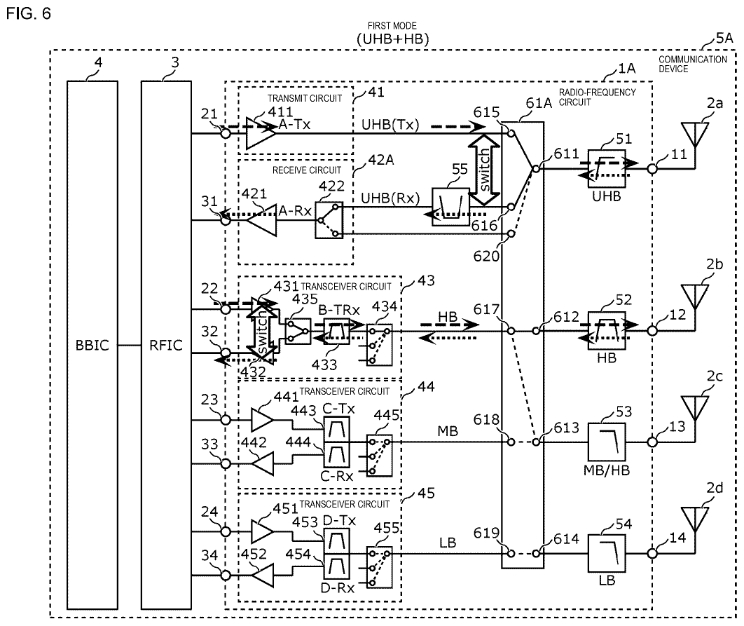

Next, as communication modes for simultaneous communication of signals of frequency bands included in the UHB and signals of frequency bands included in the HB, MB, or LB, a first mode, a second mode, and a third mode will be described with reference to FIGS. 6 to 8. In FIGS. 6 to 8, the dashed arrows indicate transmit paths and receive paths.

### 2.4.1 First Mode

First, the first mode will be described with reference to FIG. 6. FIG. 6 illustrates transmit paths and receive paths in the first mode of the radio-frequency circuit 1A according to the present embodiment.

The first mode is a communication mode for simultaneous communication of signals of the band A, which is included in the UHB, and signals of the band B, which is included in the HB. In the first mode, as illustrated in FIG. 6, the transmit circuit 41 for the UHB is connected to the antenna connection terminal 11 via the filter 51, the receive circuit 42A for the UHB is connected to the antenna connection terminal 11 via the filters 55 and 51, and the transceiver circuit 43 for the HB is connected to the antenna connection terminal 12 via the filter 52. Specifically, the switching circuit 61A selectively connects the common terminal 611 to the selection terminal 615 or 616 at different times and connects the common terminal 612 to the selection terminal 617.

With this configuration, transmit signals of the band A supplied from the RFIC 3 through the radio-frequency input terminal 21 are delivered to the antenna connection terminal 11 through the transmit circuit 41, the switching circuit 61A, and the filter 51. Receive signals of the band A supplied from the antenna 2a through the antenna connection terminal 11 are delivered to the radio-frequency output terminal 31 through the filter 51, the switching circuit 61A, the filter 55, and the receive circuit 42A. Transmit signals of the band B supplied from the RFIC 3 through the radio-frequency input terminal 22 are delivered to the antenna connection terminal 12 through the transceiver circuit 43, the switching circuit 61A, and the filter 52. Receive signals of the band B supplied from the antenna 2b via the antenna connection terminal 12 are transmitted to the radio-frequency output terminal 32 through the filter 52, the switching circuit 61A, and the transceiver circuit 43.

### 2.4.2 Second Mode

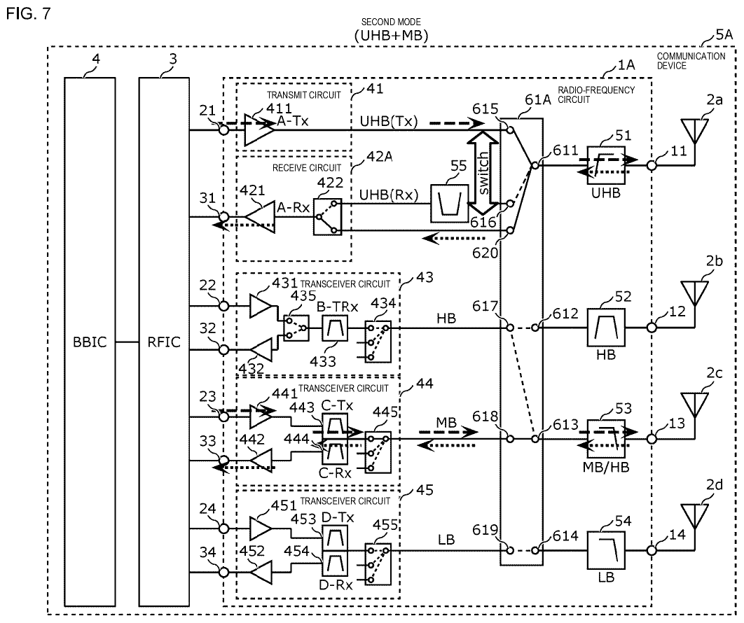

Next, the second mode will be described with reference to FIG. 7. FIG. 7 illustrates transmit paths and receive paths in the second mode of the radio-frequency circuit 1A according to the present embodiment.

The second mode is a communication mode for simultaneous communication of signals of the band A, which is included in the UHB, and signals of the band C, which is included in the MB. In the second mode, as illustrated in FIG. 7, the transmit circuit 41 and the receive circuit 42A for the UHB are connected to the antenna connection terminal 11 via the filter 51, and the transceiver circuit 44 for the MB is connected to the antenna connection terminal 13 via the filter 53. Specifically, the switching circuit 61A selectively connects the common terminal 611 to the selection terminal 615 or 620 at different times and connects the common terminal 613 to the selection terminal 618.

With this configuration, transmit signals of the band A supplied from the RFIC 3 through the radio-frequency input terminal 21 are delivered to the antenna connection terminal 11 through the transmit circuit 41, the switching circuit 61A, and the filter 51. Receive signals of the band A supplied from the antenna 2a through the antenna connection terminal 11 are delivered to the radio-frequency output terminal 31 through the filter 51, the switching circuit 61A, and the receive circuit 42A without the filter 55 being involved. Transmit signals of the band C supplied from the RFIC 3 through the radio-frequency input terminal 23 are delivered to the antenna connection terminal 13 through the transceiver circuit 44, the switching circuit 61A, and the filter 53. Receive signals of the band C supplied from the antenna 2c via the antenna connection terminal 13 are transmitted to the radio-frequency output terminal 33 through the filter 53, the switching circuit 61A, and the transceiver circuit 44.

### 2.4.3 Third Mode

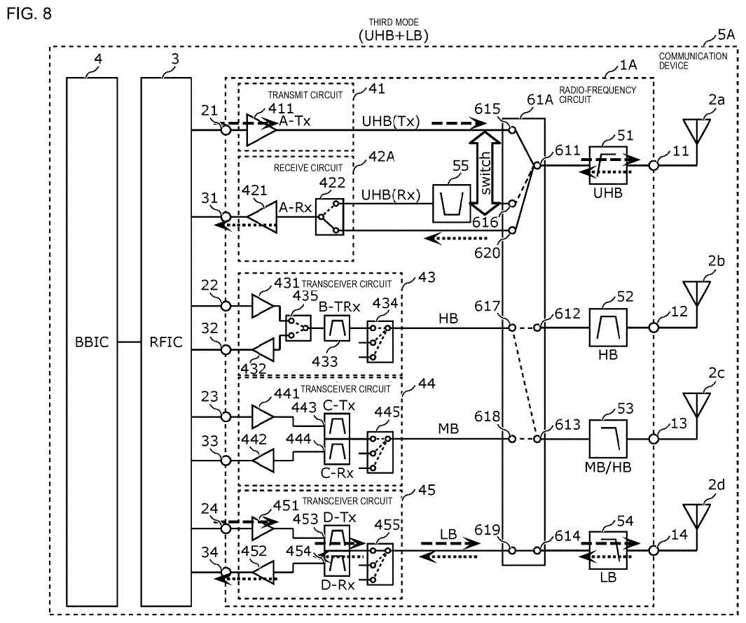

Finally, the third mode will be described with reference to FIG. 8. FIG. 8 illustrates transmit paths and receive paths in the third mode of the radio-frequency circuit 1A according to the present embodiment.

The third mode is a communication mode for simultaneous communication of signals of the band A, which is included in the UHB, and signals of the band D, which is included in the LB. In the third mode, as illustrated in FIG. 8, the transmit circuit 41 and the receive circuit 42A for the UHB are connected to the antenna connection terminal 11 via the filter 51, and the transceiver circuit 45 for the LB is connected to the antenna connection terminal 14 via the filter 54. Specifically, the switching circuit 61A selectively connects the common terminal 611 to the selection terminal 615 or 620 at different times and connects the common terminal 614 to the selection terminal 619.

With this configuration, transmit signals of the band A supplied from the RFIC 3 through the radio-frequency input terminal 21 are delivered to the antenna connection terminal 11 through the transmit circuit 41, the switching circuit 61A, and the filter 51. Receive signals of the band A supplied from the antenna 2a through the antenna connection terminal 11 are delivered to the radio-frequency output terminal 31 through the filter 51, the switching circuit 61A, and the receive circuit 42A without the filter 55 being involved. Transmit signals of the band D supplied from the RFIC 3 through the radio-frequency input terminal 24 are delivered to the antenna connection terminal 14 through the transceiver circuit 45, the switching circuit 61A, and the filter 54. Receive signals of the band D supplied from the antenna 2d via the antenna connection terminal 14 are transmitted to the radio-frequency output terminal 34 through the filter 54, the switching circuit 61A, and the transceiver circuit 45.

The first mode, the second mode, and the third mode have been described above with reference to FIGS. 6 to 4. However, multiple communication modes that the radio-frequency circuit 1A can utilize are not limited to the first mode, the second mode, and the third mode. For example, communication modes that enable simultaneous communication using a combination of HB and MB, a combination of MB and LB, a combination of HB and LB, a combination of UHB, HB, and MB, a combination of UHB, HB, and LB, a combination of UHB, MB, and LB, or a combination of UHB, HB, MB, and LB may be usable. Alternatively, for example, communication modes for communication on one or more frequency bands included in a single band group may be usable.

### 2.5 Conclusion

As described above, the radio-frequency circuit 1A according to the present embodiment includes: the switching circuit 61A including the common terminal 611 connected to the antenna connection terminal 11, the common terminal 612 connected to the antenna connection terminal 12, the common terminal 613 connected to the antenna connection terminal 13, the common terminal 614 connected to the antenna connection terminal 14, the selection terminal 615 connected to the transmit circuit 41 for the UHB, the selection terminal 616 connected to the receive circuit 42A for the UHB, the selection terminal 617 connected to the transceiver circuit 43 for the HB, the selection terminal 618 connected to the transceiver circuit 44 for the MB, and the selection terminal 619 connected to the transceiver circuit 45 for the LB; the filter 51 connected between the common terminal 611 and the antenna connection terminal 11, the filter 51 having a pass band that includes the UHB; the filter 52 connected between the common terminal 612 and the antenna connection terminal 12, the filter 52 having a pass band that includes the HB; the filter 53 connected between the common terminal 613 and the antenna connection terminal 13, the filter 53 having a pass band that includes the HB and the MB; the filter 54 connected between the common terminal 614 and the antenna connection terminal 14, the filter 54 having a pass band that includes the LB; and the filter 55 connected between the selection terminal 616 and the receive circuit 42A, the filter 55 having an attenuation band that includes the HB.

In this configuration, the filter 55 having an attenuation band that includes the HB is connected between the selection terminal 616 of the switching circuit 61A and the receive circuit 42A. Thus, leakage of signals of the HB into the receive path for the UHB can be suppressed. As a result, when the radio-frequency circuit 1A for the UHB, HB, MB, and LB is implemented on a single module board (in other words, when the radio-frequency circuit 1A is implemented as a single module), isolation between the receive circuit 42A for the UHB and the transceiver circuit 43 for the HB can be ensured, thereby contributing to miniaturization of the communication device 5A. Furthermore, in the radio-frequency circuit 1A, the switching circuit 61A switches between transmission and reception of signals of the UHB, and the filter 55 is not inserted into the transmit path for the UHB. This configuration can suppress loss of transmit signals of the UHB caused by the filter 55.

In one example, in the radio-frequency circuit 1A according to the present embodiment, the filter 51 may be a high pass filter.

This configuration can relatively easily implement the filter 51.

In one example, in the radio-frequency circuit 1A according to the present embodiment, the filter 51 may be a band pass filter.

This configuration enables the filter 51 to attenuate harmonic distortion in the transmit paths for the UHB and/or the receive paths for the UHB.

In one example, in the radio-frequency circuit 1A according to the present embodiment, the filter 51 may be an LC filter.

Since an LC filter, which has relatively low loss and a wide pass band, is used for the filter 51 in this configuration, filter characteristics suitable for the UHB, which is a relatively wide band, can be achieved with the filter 51.

In one example, in the radio-frequency circuit 1A according to the present embodiment, the filter 55 may be an LC filter.

Since an LC filter, which has relatively low loss and a wide attenuation band, is used for the filter 55 in this configuration, filter characteristics suitable for attenuating signals of the HB, which is a relatively wide band, can be achieved with the filter 55.

As described above, in the radio-frequency circuit 1A according to the present embodiment, the switching circuit 61A may further include the selection terminal 620 that is connected to the receive circuit 42A without the filter 55 being involved.

In this configuration, the selection terminal 620 of the switching circuit 61A is connected to the receive circuit 42A without the filter 55 being involved. Accordingly, when leakage of HB signals into the receive path for the UHB is relatively small, loss of UHB receive signals can be suppressed by connecting the receive circuit 42A to the antenna connection terminal 11 without the filter 55 being involved.

In one example, in the radio-frequency circuit 1A according to the present embodiment, in the first mode for simultaneous communication of UHB signals and HB signals, the switching circuit 61A may (i) selectively connect the common terminal 611 to the selection terminal 615 or 616 at different times and (ii) connect the common terminal 612 to the selection terminal 617; in the second mode for simultaneous communication of UHB signals and MB signals, the switching circuit 61A may (iii) selectively connect the common terminal 611 to the selection terminal 615 or 620 at different times and (iv) connect the common terminal 613 to the selection terminal 618; in the third mode for simultaneous communication of UHB signals and LB signals, the switching circuit 61A may (v) selectively connect the common terminal 611 to the selection terminal 615 or 620 at different times and (vi) connect the common terminal 614 to the selection terminal 619.

With this configuration, in the first mode in which UHB signals and HB signals are simultaneously communicated, the filter 55 is involved in the UHB receive path. Accordingly, leakage of HB signals into the UHB receive path can be effectively suppressed. In the second mode and the third mode in which UHB signals and HB signals are not simultaneously communicated, the filter 55 is not involved in the UHB receive path. Accordingly, loss of UHB receive signals can be effectively suppressed.

In one example, the communication device 5A according to the present embodiment includes the RFIC 3 for processing radio-frequency signals and the radio-frequency circuit 1A for delivering radio-frequency signals between the antennas 2a to 2d and the RFIC 3.

This configuration enables the communication device 5A to achieve the same effects as the radio-frequency circuit 1A.

### OTHER EMBODIMENTS

The radio-frequency circuit and the communication device according to the present disclosure have been described above based on the embodiments. However, the radio-frequency circuit and the communication device according to the present disclosure are not limited to the embodiments. The present disclosure also embraces other embodiments implemented by any combination of the constituent elements of the embodiments, other modifications obtained by making various modifications to the embodiments described above that occur to those skilled in the art without departing from the scope of the present disclosure, and various hardware devices including the radio-frequency circuit.

For example, in the different circuit configurations according to the embodiments described above, other circuit elements and/or interconnections may also be inserted in the paths connecting the circuit elements and the signal paths that are illustrated in the drawings. For example, impedance matching circuits may be inserted between amplifiers and filters. An impedance matching circuit may be constituted by, for example, inductors and/or capacitors. However, the impedance matching circuit is not particularly limited.

The following describes the features of the radio-frequency circuit and the communication device explained based on the embodiments.

<1>

A radio-frequency circuit comprising:
a switching circuit including a first common terminal connected to a first antenna connection terminal, a second common terminal connected to a second antenna connection terminal, a third common terminal connected to a third antenna connection terminal, a fourth common terminal connected to a fourth antenna connection terminal, a first selection terminal connected to a first transmit circuit for an ultra high band group (3300-5000 MHz), a second selection terminal connected to a first receive circuit for the ultra high band group, a third selection terminal connected to at least one of a second transmit circuit and a second receive circuit for a high band group (2300-2690 MHz), a fourth selection terminal connected to at least one of a third transmit circuit and a third receive circuit for a mid band group (1427-2200 MHz), and a fifth selection terminal connected to at least one of a fourth transmit circuit and a fourth receive circuit for a low band group (617-960 MHz);
a first filter connected between the first common terminal and the first antenna connection terminal, the first filter having a pass band that includes the ultra high band group;
a second filter connected between the second common terminal and the second antenna connection terminal, the second filter having a pass band that includes the high band group;
a third filter connected between the third common terminal and the third antenna connection terminal, the third filter having a pass band that includes the high band group and the mid band group;
a fourth filter connected between the fourth common terminal and the fourth antenna connection terminal, the fourth filter having a pass band that includes the low band group; and
a fifth filter connected between the second selection terminal and the first receive circuit, the fifth filter having an attenuation band that includes the high band group.
   <2>

The radio-frequency circuit according to <1>, wherein
the first filter is a high pass filter.
   <3>

The radio-frequency circuit according to <1>, wherein
the first filter is a band pass filter.
   <4>

The radio-frequency circuit according to any one of <1> to <3>, wherein
the first filter is an LC filter.
   <5>

The radio-frequency circuit according to any one of <1> to <4>, wherein
the fifth filter is an LC filter.
   <6>

The radio-frequency circuit according to any one of <1> to <5>, wherein
in a first mode for simultaneous communication of the ultra high band group signal and the high band group signal, the switching circuit (i) selectively connects the first common terminal to the first selection terminal or the second selection terminal at different times and (ii) connects the second common terminal to the third selection terminal,
in a second mode for simultaneous communication of the ultra high band group signal and the mid band group signal, the switching circuit (iii) selectively connects the first common terminal to the first selection terminal or the second selection terminal at different times and (iv) connects the third common terminal to the fourth selection terminal, and
in a third mode for simultaneous communication of the ultra high band group signal and the low band group signal, the switching circuit (v) selectively connects the first common terminal to the first selection terminal or the second selection terminal at different times and (vi) connects the fourth common terminal to the fifth selection terminal.
   <7>

The radio-frequency circuit according to any one of <1> to <5>, wherein
the switching circuit further includes a sixth selection terminal connected to the first receive circuit without the fifth filter being involved.
   <8>

The radio-frequency circuit according to <7>, wherein
in a first mode for simultaneous communication of the ultra high band group signal and the high band group signal, the switching circuit (i) selectively connects the first common terminal to the first selection terminal or the second selection terminal at different times and (ii) connects the second common terminal to the third selection terminal,
in a second mode for simultaneous communication of the ultra high band group signal and the mid band group signal, the switching circuit (iii) selectively connects the first common terminal to the first selection terminal or the sixth selection terminal at different times and (iv) connects the third common terminal to the fourth selection terminal, and
in a third mode for simultaneous communication of the ultra high band group signal and the low band group signal, the switching circuit (v) selectively connects the first common terminal to the first selection terminal or the sixth selection terminal at different times and (vi) connects the fourth common terminal to the fifth selection terminal.
   <9>

A communication device comprising:
a signal processing circuit configured to process a radio-frequency signal; and
the radio-frequency circuit according to any one of <1> to <8>, the radio-frequency circuit being configured to deliver the radio-frequency signal between an antenna and the signal processing circuit.

### INDUSTRIAL APPLICABILITY

The present disclosure can be used as a radio-frequency circuit provided at the front-end, in a wide variety of communication hardware, such as mobile phones.

### REFERENCE SIGNS LIST

1, 1A radio-frequency circuit
2a, 2b, 2c, 2d antenna
3 RFIC
4 BBIC
5, 5A communication device
11, 12, 13, 14 antenna connection terminal
21, 22, 23, 24 radio-frequency input terminal
31, 32, 33, 34 radio-frequency output terminal
41 transmit circuit
42, 42A receive circuit
43, 44, 45 transceiver circuit
51, 52, 53, 54, 55, 433, 443, 444, 453, 454 filter
61, 61A, 422, 434, 435, 445, 455 switching circuit
411, 431, 441, 451 power amplifier
421, 432, 442, 452 low-noise amplifier
611, 612, 613, 614 common terminal
615, 616, 617, 618, 619, 620 selection terminal

1. A radio-frequency circuit comprising:
a switching circuit including a first common terminal connected to a first antenna connection terminal, a second common terminal connected to a second antenna connection terminal, a third common terminal connected to a third antenna connection terminal, a fourth common terminal connected to a fourth antenna connection terminal, a first selection terminal connected to a first transmit circuit for an ultra high band group (3300-5000 MHz), a second selection terminal connected to a first receive circuit for the ultra high band group, a third selection terminal connected to at least one of a second transmit circuit and a second receive circuit for a high band group (2300-2690 MHz), a fourth selection terminal connected to at least one of a third transmit circuit and a third receive circuit for a mid band group (1427-2200 MHz), and a fifth selection terminal connected to at least one of a fourth transmit circuit and a fourth receive circuit for a low band group (617-960 MHz);
a first filter connected between the first common terminal and the first antenna connection terminal, the first filter having a pass band that includes the ultra high band group;
a second filter connected between the second common terminal and the second antenna connection terminal, the second filter having a pass band that includes the high band group;
a third filter connected between the third common terminal and the third antenna connection terminal, the third filter having a pass band that includes the high band group and the mid band group;
a fourth filter connected between the fourth common terminal and the fourth antenna connection terminal, the fourth filter having a pass band that includes the low band group; and
a fifth filter connected between the second selection terminal and the first receive circuit, the fifth filter having an attenuation band that includes the high band group.

2. The radio-frequency circuit according to claim 1, wherein
the first filter is a high pass filter.

3. The radio-frequency circuit according to claim 1, wherein
the first filter is a band pass filter.

4. The radio-frequency circuit according to claim 1, wherein
the first filter is an LC filter.

5. The radio-frequency circuit according to claim 1, wherein
the fifth filter is an LC filter.

6. The radio-frequency circuit according to claim 1, wherein
in a first mode for simultaneous communication of a signal of the ultra high band group and a signal of the high band group, the switching circuit is configured to (i) selectively connect the first common terminal to the first selection terminal or the second selection terminal at different times and (ii) connect the second common terminal to the third selection terminal,
in a second mode for simultaneous communication of a signal of the ultra high band group and a signal of the mid band group, the switching circuit is configured to (iii) selectively connect the first common terminal to the first selection terminal or the second selection terminal at different times and (iv) connect the third common terminal to the fourth selection terminal, and
in a third mode for simultaneous communication of a signal of the ultra high band group and a signal of the low band group, the switching circuit is configured to (v) selectively connect the first common terminal to the first selection terminal or the second selection terminal at different times and (vi) connect the fourth common terminal to the fifth selection terminal.

7. The radio-frequency circuit according to claim 1, wherein
the switching circuit further includes a sixth selection terminal connected to the first receive circuit without the fifth filter being involved.

8. The radio-frequency circuit according to claim 7, wherein
in a first mode for simultaneous communication of a signal of the ultra high band group and a signal of the high band group, the switching circuit is configured to (i) selectively connect the first common terminal to the first selection terminal or the second selection terminal at different times and (ii) connect the second common terminal to the third selection terminal,
in a second mode for simultaneous communication of a signal of the ultra high band group and a signal of the mid band group, the switching circuit is configured to (iii) selectively connect the first common terminal to the first selection terminal or the sixth selection terminal at different times and (iv) connect the third common terminal to the fourth selection terminal, and
in a third mode for simultaneous communication of a signal of the ultra high band group and a signal of the low band group signal, the switching circuit is configured to (v) selectively connect the first common terminal to the first selection terminal or the sixth selection terminal at different times and (vi) connect the fourth common terminal to the fifth selection terminal.

9. The radio-frequency circuit according to claim 7, wherein the first receive circuit includes a second switching circuit connected between the fifth filter and the sixth selection terminal, the second switching circuit being configured to selectively connect the first receive circuit to either the second selection terminal via the fifth filter or the sixth selection terminal without the fifth filter.

10. The radio-frequency circuit according to claim 1, wherein the fifth filter is a band elimination filter having the attenuation band that includes the high band group and a pass band that includes the ultra high band group.

11. The radio-frequency circuit according to claim 1, wherein the switching circuit includes a first integrated circuit covering the ultra high band group, the high band group, and the mid band group, and a second integrated circuit covering the low band group.

12. The radio-frequency circuit according to claim 1, wherein the first transmit circuit includes a power amplifier configured to amplify a transmit signal of the ultra high band group, and the first receive circuit includes a low-noise amplifier configured to amplify a receive signal of the ultra high band group.

13. The radio-frequency circuit according to claim 1, wherein the radio-frequency circuit is implemented on a single module board.

14. A communication device comprising:
a signal processing circuit configured to process a radio-frequency signal; and
the radio-frequency circuit according to claim 1, the radio-frequency circuit being configured to deliver a radio-frequency signal between an antenna and the signal processing circuit.

15. A method of operating a radio-frequency circuit for multi-band wireless communication, the method comprising:
routing, by a switching circuit, a first transmit signal of an ultra high band group (3300-5000 MHz) from a first transmit circuit through a first common terminal to a first antenna connection terminal via a first filter having a pass band that includes the ultra high band group;
routing, by the switching circuit, a first receive signal of the ultra high band group from the first antenna connection terminal via the first filter through the first common terminal to a second selection terminal; and
filtering, by a fifth filter connected between the second selection terminal and a first receive circuit, the first receive signal to attenuate signal components in a high band group (2300-2690 MHz) before the first receive signal reaches the first receive circuit.

16. The method according to claim 15, further comprising simultaneously communicating signals of the ultra high band group and signals of the high band group, wherein during the simultaneous communication, the switching circuit selectively connects the first common terminal to the first transmit circuit or to the second selection terminal at different times.
